(19) United States
(12) Patent Application Publication
(10) Pub. No.: US 2006/0249639 A1
(43) Pub. Date: Nov. 9, 2006

(54) Device for storing a shaving razor or other implement with an associated container

(76) Inventor: William S. Bisceglia, Rye, NY (US)

Correspondence Address: LAW OFFICE OF LEO ZUCKER, 25 BANK STREET, SUITE 221-L, PO BOX 1194, WHITE PLAINS, NY, 10602-1194, US

(21) Appl. No.: 11/409,370

(22) Filed: Apr. 22, 2006

Related U.S. Application Data
(60) Provisional application No. 60/674,421, filed on Apr. 25, 2005.

(51) Int. Cl. B44D 3/12; F16M 11/00

(52) U.S. Cl. 248/213.2; 248/682; 248/229.16

(57) ABSTRACT

A device for storing an implement on a container or can whose contents require use of the implement. An elastic band is formed to fit securely on the can's circumference. A mouth formed on the periphery of the band engages a part of the implement. The mouth includes a pair of arms that extend radially from the band, and a pair of resilient gates each joined at a first end to a radially outer end of a corresponding arm. Each gate is biased toward a first position where a second end of the gate opposite its first end confronts the second end of the other gate. The gates deflect to a second position between the arms when so urged by a part of the implement, and then return to the first position once the implement clears the second ends of the gates to assume a storage position adjacent the can.

### CROSS REFERENCE TO RELATED APPLICATION

This application claims priority under 35 U.S.C. § 119(e) of U.S. Provisional Patent Application No. 60/674,421 filed Apr. 25, 2005, in the name of the present inventor and entitled “Device for Holding a Cosmetic Implement Such as a Razor”.

### BACKGROUND OF THE INVENTION

1. Field of the Invention

This invention concerns devices for holding or storing shaving razors and other implements while such implements are not in use.

2. Discussion of the Known Art

U.S. Pat. No. 5,544,783 (Aug. 13, 1996) discloses a straw tube holder for aerosol spray cans. The holder is in the form of a flexible C-clip that clamps about the circumference of an associated can. A pair of C-shaped brackets are formed on the circumference of the clip, and the brackets are dimensioned to grip hollow spray tubes or “straws” that are used to apply the contents of the can.

U.S. Pat. No. 5,806,669 (Sep. 15, 1998) discloses a razor support structure which in one embodiment includes a large clip portion that partially encircles a can of shaving cream, and a small clip portion fixed to the large clip portion. The small clip portion has a pair of outwardly extended end portions for grasping the handle of a razor. U.S. Pat. No. 4,695,029 (Sep. 22, 1987) also describes a device for securing a razor on a can of shaving cream. The device of the '029 patent includes a plastics collar that can snap on and off an upper portion of the can, and a flange that extends outward from the collar. An opening formed in the flange receives the handle of the razor, and the blade head of the razor rests on the flange. See also, U.S. Pat. No. 4,320,832 (Mar. 23, 1982), and No. 4,656,738 (Apr. 14, 1987); and U.S. Design Patents D-409,087 (May 4, 1999), and D-315,306 (Mar. 12, 1991).

There remains a need for a device that can be easily fixed to a can containing, for example, shaving cream, and which enables a corresponding implement (e.g., a shaving razor) to engage the device safely for storage while the can and the razor are not in use, and allows the razor to disengage safely from the device for use when desired. It is also desirable that the device be suited for large scale production at relatively low cost.

### SUMMARY OF THE INVENTION

According to the invention, a device for storing an implement together with a can whose contents require use of the implement, includes an elastic band dimensioned to fit securely on the outside circumference of the can after the band is stretched and released about the circumference, and a mouth portion fixed on the outer periphery of the band for engaging the implement. The mouth portion has a pair of arms that extend radially from the band and are spaced apart by an amount sufficient to receive a part of the implement when said part is inserted between the arms. The mouth portion also includes a pair of resilient flaps or gates each of which is joined at a first end to a radially outer end of a corresponding arm.

Each gate is biased toward a first, rest position at which a second end of the gate opposite its first end closely confronts or abuts the second end of the other gate. The gates are formed to deflect to a second position between the side walls when urged by a part of the implement, and to return to the first position once the implement clears the second ends of the gates so that the implement is retained by the device at a storage position in proximity to the can.

For a better understanding of the invention, reference is made to the following description taken in conjunction with the accompanying drawing and the appended claims.

### BRIEF DESCRIPTION OF THE DRAWING

In the drawing:

FIG. 1 is a perspective view showing the inventive storing device as fitted on a can of shaving cream;

FIG. 2 is a view similar to FIG. 1, showing a safety razor engaged by the inventive device for storage adjacent the can;

FIG. 3 is a top view of the fitted storing device in FIG. 1; and

FIG. 4 is a side elevation view of the fitted storing device in FIG. 1.

### DETAILED DESCRIPTION OF THE INVENTION

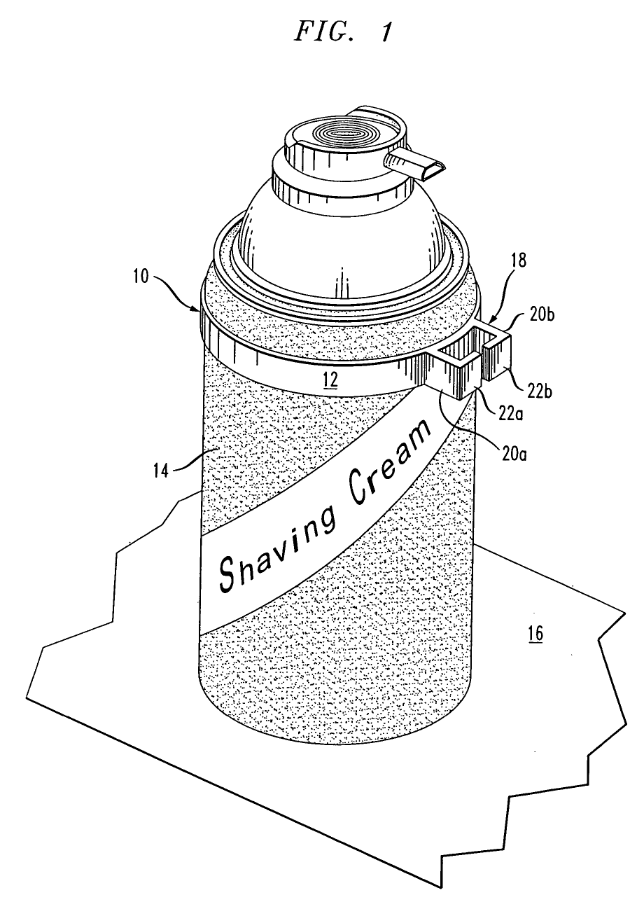

FIG. 1 shows a storing device 10 according to the invention. Although the device 10 is illustrated as fitted on a pressurized can 14 of shaving cream, it will be understood that the device 10 may be applied on various containers of other kinds of ingredients for which it may be convenient to hold or store an associated implement that is used for applying or otherwise dispensing the contents of the container.

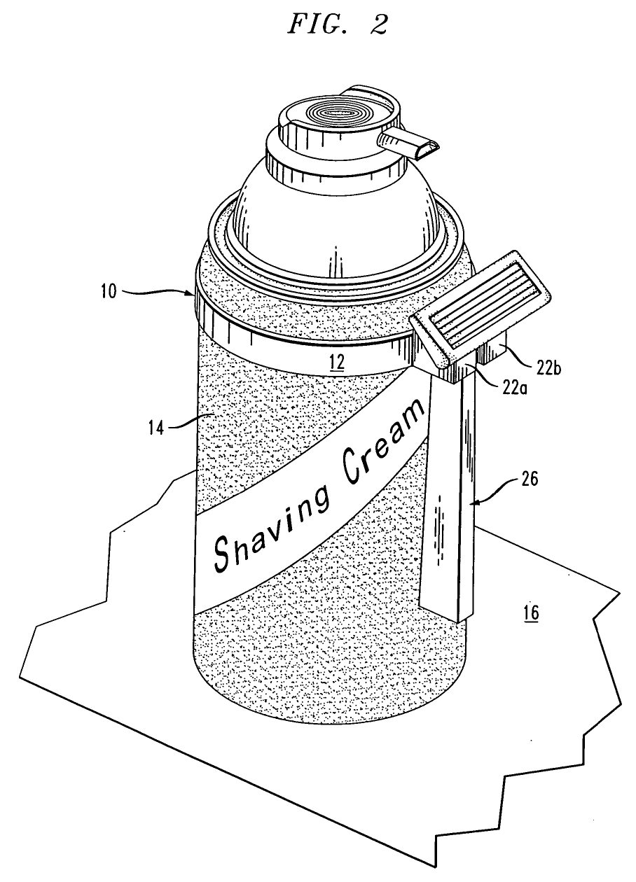

The device 10 includes an elastic band 12 that is dimensioned to surround and grip the outside circumference of the can 14 by friction, after the band 12 is stretched and released about the can 14 at a desired height as shown in FIG. 1. Preferably, the band 12 is disposed a sufficient height on the can 14 so that a bottom end of an implement stored by the device 10 is kept clear of a rest surface 16 on which the can 14 rests, once the implement is retained by the device 10. See, e.g., the safety razor 26 in FIG. 2.

The device 10 also has a mouth portion 18. The mouth portion 18 is fixed on the outer periphery of the band 12, and is formed with a pair of side walls or arms 20a, 20b that project radially outward from the band. The arms 20a, 20b are spaced apart by an amount sufficient to receive a part of the implement to be stored (e.g., the upper neck of the razor 26 in FIG. 2) when the implement is inserted between the arms 20a, 20b. The mouth portion 18 also includes a pair of flaps or gates 22a, 22b each of which is joined at a first end to a radially outer end of a corresponding arm 20a, 20b.

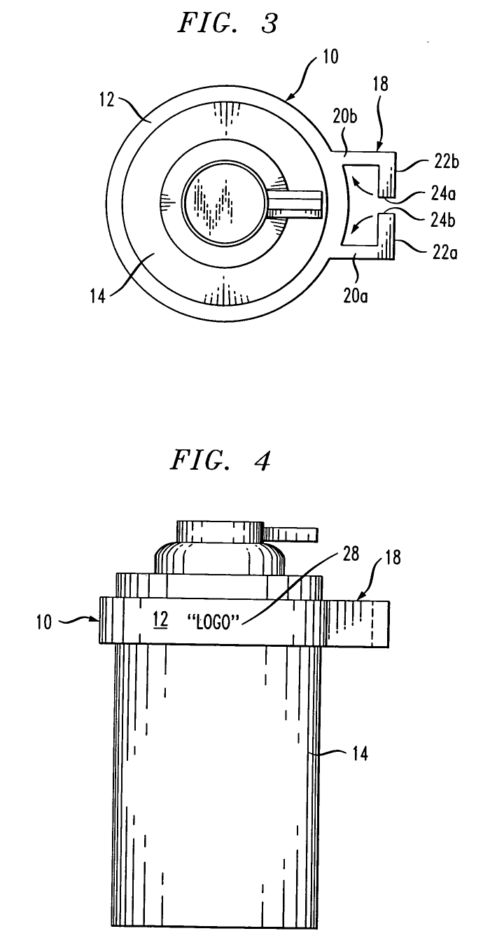

The storing device 10 may be formed integrally from an elastomeric material such as, for example, silicone rubber, SBR, NBR, or EPDM. The gates 22a, 22b of the mouth portion 18 are therefore biased by the material of the device toward a first, rest position at which a second end 24a, 24b (see FIG. 3) of each gate opposite its first end, closely confronts or abuts the second end 24b, 24a of the other gate. Thus, the band 12, the arms 20a, 20b and the gates 22a, 22b together form a substantially closed rectangular space in a horizontal plane when the gates are at the rest position, as seen in FIG. 3.

The arms 20a, 20b and the gates 22a, 22b of the mouth portion 18 are also formed so that, when urged by a part (e.g., a handle) of the implement, the gates deflect resiliently in the direction of the arrows in FIG. 3 to a second position within the rectangular space between the arms; and then return to the first position in FIG. 3 once the implement clears the deflected second ends of the gates. The implement, e.g., the safety razor 26 in FIG. 2, is then retained at a storage position next to the can 14.

If the cross section of the retained part of the implement is wider than the rest spacing between the arms 20a, 20b, the arms will retain the implement by friction at the storage position. If the cross-section of the implement does not exceed the bounds of the rectangular space between the arms 20a, 20b, the implement may slide vertically downward through the space until a widened top part of the implement rests on the arms 20a, 20b. See, for example, the razor head in FIG. 2.

As shown FIG. 4, various indicia 28 may be displayed using, e.g., a silk screen printing process, embossing, or debossing on the outer or inner periphery of the band 12. For example, a brand name of shaving cream contained in the can 10, the user's or another company's name. Pigments or dyes may be added to the material of the device 10 so as to produce the device in one or more desired colors. As mentioned, although a pressurized can of shaving cream is illustrated in the disclosed embodiment, it will be understood that the device 10 may be used in conjunction with a variety of cans, plastics bottles or containers the contents of which include a preparation or ingredient whose application requires an implement that can safely engage the device.

To use the device 10, the band 12 is stretched over the can 14 and brought to a position just below a top rim of the can. If the can has a nozzle as provided on a can of shaving cream, the nozzle should be rotated to a 12:00 position, while the mouth portion 18 of the device is preferably placed at 9:00 if the user is right-handed or at 3:00 if the user is left-handed. The neck of the razor (or other implement) is pushed through the gates 22a, 22b of the mouth portion, so as to engage the razor with the device 10 for storage. The can should not be shaken while the razor is engaged with the device 10, unless the handle of the razor is urged by the user's thumb safely against the side of the can.

The razor neck may then be pulled out of the gates 22a, 22b in order to disengage the razor from the device 10, when the razor is to be used. When the can is empty, the device 10 may be removed and cleaned with mild soap and warm water. For safety, any razor blade guard supplied with the razor should continue to be used while the razor is stored on the device 10. The guard may be placed, e.g., on top of the mouth portion 18 while the user is shaving.

### EXAMPLE ONE

Silicone rubber having a durometer of 50 was injection molded and cured at 425 degrees F. to form a storing device 10 having the following dimensions:

| Inside diameter of band 12: | 2⅜ | inches. |
|---|---|---|
| Outside diameter of band 12: | 2½ | inches. |
| Thicknesses of band 12 and gates 22a, 22b: | 1/16 | inch. |
| Thickness of band 12 between arms 20a, 20b: | ⅛ | inch. |
| Widths of band 12, gates 22a, 22b and | ½ | inch. |
| arms 20a, 20b: | | |
| Thickness of arms 20a, 20b: | ⅛ | inch. |
| Inside clear dimensions of mouth opening 18: | ½″ between arms × | |
| | 7/16″ between band and | |
| | gates. | |
| Gap between confronting (second) ends | 1/16 | inch. |
| of gates 22a, 22b: | | |

The device of Example One was used successfully to store various shaving razors on cans having an outside diameter of 2½ inches.

### EXAMPLE TWO

Silicone rubber having a durometer of 50 was injection molded and cured at 425 degrees F. to form a storing device 10 having the following dimensions:

| Inside diameter of band 12: | 1⅞ | inches. |
|---|---|---|
| Outside diameter of band 12: | 2 | inches. |
| Thicknesses of band 12 and gates 22a, 22b: | 1/16 | inch. |
| Thickness of band 12 between arms 20a, 20b: | ⅛ | inch. |
| Widths of band 12, gates 22a, 22b and | ½ | inch. |
| arms 20a, 20b: | | |
| Thickness of arms 20a, 20b: | ⅛ | inch. |
| Inside clear dimensions of mouth opening 18: | ½″ between arms × | |
| | 7/16″ between band and | |
| | gates. | |
| Gap between confronting (second) ends | 1/16 | inch. |
| of gates 22a, 22b: | | |

The device of Example Two was used successfully to store various shaving razors on cans having an outside diameter of 2 inches.

While the foregoing represents preferred embodiments of the invention, it will be understood by those skilled in the art that various modifications and changes may be made without departing from the spirit and scope of the invention, and that the invention includes all such modifications and changes are within the scope of the following claims.

1. A device for storing an implement together with a container whose contents require use of the implement, comprising:
an elastic band dimensioned to fit securely on an outside circumference of the container after the band is stretched and released about said circumference;
a mouth portion fixed on the outer periphery of the band for engaging the implement, wherein the mouth portion includes,
a pair of arms that extend radially from the band and are spaced apart by an amount sufficient to receive a part of the implement when said part is inserted between the arms; and
a pair of resilient gates each of which is joined at a first end to a radially outer end of a corresponding arm so that each gate is biased toward a first, rest position at which a second end of the gate opposite its first end closely confronts or abuts the second end of the other gate;
wherein the gates are formed to deect to a second position between the side walls when urged by a part of the implement, and to return to the first position once the implement clears the second ends of the gates, so that the implement is retained in the mouth portion of the device at a storage position in proximity to the container.

2. A device according to claim 1, wherein the device is formed of silicone rubber.

3. The device of claim 2, wherein the silicone rubber is injection molded to form the device.

4. The device of claim 2, wherein the silicone rubber has a durometer of approximately 50.

5. A device according to claim 1, wherein the elastic band has indicia displayed on either an outer or an inner periphery of the band.

6. The device of claim 5, wherein the indicia comprises a brand name.

7. The device of claim 6, wherein said brand name is associated with a shaving cream.

8. A device according to claim 1, wherein the second ends of said gates form a gap of approximately 1/16 inch when the gates are at said first position.

9. A device according to claim 1, wherein the arms and the gates of said mouth portion are dimensioned and arranged for retaining part of a handle of a razor in said storage position in proximity to the container.

10. A device for storing an implement together with a container whose contents require use of the implement, comprising:
an elastic band formed of silicone rubber and dimensioned to fit securely on an outside circumference of the container after the band is stretched and released about said circumference; and
a mouth portion fixed on the outer periphery of the band for receiving the implement, wherein the mouth portion includes a pair of arms that project radially outward from the band and are spaced apart by an amount sufficient to support a part of the implement to be stored when the implement is inserted between the arms.

11. A device according to claim 10, wherein the silicone rubber is injection molded to form the device.

12. The device of claim 10, wherein the silicone rubber has a durometer of approximately 50.

13. A device according to claim 10, wherein the elastic band has indicia displayed on either an outer or an inner periphery of the band.

14. The device of claim 13, wherein the indicia comprises a brand name.

15. The device of claim 14, wherein said brand name is associated with a shaving cream.

16. A device according to claim 10, wherein the arms of said mouth portion are dimensioned and arranged for retaining part of a handle of a razor in said storage position in proximity to the container.
